(19) United States
(12) Patent Application Publication
(10) Pub. No.: US 2025/0383463 A1
(43) Pub. Date: Dec. 18, 2025

(54) CARBON DIOXIDE STORAGETARGET RESERVOIRMODIFIEDFRACTURE CHARACTERIZATION AND PERMEABILITY-INCREASING EFFECT EVALUATION METHOD

(71) Applicant: China University of Mining and Technology, Xuzhou (CN)

(72) Inventors: Xiaofei Liu, Xuzhou (CN); Xiaoran Wang, Xuzhou (CN); Enyuan Wang, Xuzhou (CN); Shuxin Liu, Xuzhou (CN); Dongjie Wang, Xuzhou (CN); Qiming Zhang, Xuzhou (CN); Xin Zhou, Xuzhou (CN); Duke Cai, Xuzhou (CN); Hui Xie, Xuzhou (CN); Jiaxin Shao, Xuzhou (CN)

(21) Appl. No.: 19/035,337

(22) Filed: Jan. 23, 2025

(30) Foreign Application Priority Data
Jun. 14, 2024 (CN) 202410765569.0

(51) Int. Cl. G01V 1/30; E21B 41/00; E21B 43/26; E21B 49/00; G01V 1/133; G01V 1/42

(52) U.S. Cl. CPC G01V 1/306; E21B 41/0064; E21B 43/2605; E21B 49/00; G01V 1/133; G01V 1/303; G01V 1/42

(57) ABSTRACT

The present invention discloses a carbon dioxide storage target reservoir modified fracture characterization and permeability-increasing effect evaluation method. The evaluation method includes the following steps: enlarging a storage target reservoir fracture network structure, utilizing microseismic monitoring to obtain fracture development waveform data, obtaining a fracture connectivity from three dimensions of a fracture source spacing, a fracture size and a fracture orientation, determining a fracture density by utilizing three-dimensional volume number density of locating points, characterizing a rock mass permeation capability based on a maximum eigenvalue and a corresponding eigenvector of a fracture damage tensor, quantitatively characterizing a storage target reservoir rock mass fracturing and permeability-increasing modified fracture network from three dimensions of connectivity, density and permeability of a target reservoir rock mass, and instantly assessing a permeability-increasing effect of the fracture network structure to achieve storage target reservoir fracture network modification effect maximization.

### CROSS-REFERENCE TO RELATED APPLICATIONS

This is a U.S. patent application which claims the priority and benefit of Chinese Patent Application Number 202410765569.0, filed on Jun. 14, 2024, the disclosure of which is incorporated herein by reference in its entirety.

### TECHNICAL FIELD

The present invention relates to the technical field of CO₂ mineralization storage, in particular to a carbon dioxide storage target reservoirmodified fracture characterization and permeability-increasing effect evaluation method.

### BACKGROUND

The carbon capture, utilization and storage (CCUS) technology is an indispensable technology to achieve low carbonization of fossil energy sources, in which geological storage is an important means to achieve emission reduction and sink increasement and is a driving force to solve the fate of captured CO₂. Conventional storage geological storage at home and abroad is to inject CO₂ at a high pressure into storage geological bodies of underground porous rock mass reservoirs, oil reservoirs, coal seams, deep saline aquifers, etc. for storage. However, this technology faces problems of high storage costs, high risks of re-leakage, and even inductions of engineering disasters. A new generation of geological storage technology-mineralization storage is capable of achieving more stable CO₂ underground storage, moreover mineralization storage carbon-based mineral storage rock strata are widely distributed, and the CO₂ injection cost is low. These advantages give CO₂ mineralization storage a great potential.

In order that CO₂ is injected into a storage target reservoir to make full contact with a carbon-based mineral rock mass for making a mineralization reaction, a fracture network of a mineralization storage target reservoir is modified to increase rock mass permeation capability, achieving the maximization of mineralization utilization of an object storagereservoir. Patent CN117468908A proposes a new method of increasing recovery by pressure flooding of medium and low permeability reservoirs, a fracture formation process achieves slow extension, and long fractures are formed to achieve effective expansion of volumes. Patent CN114541964A uses a method of sequestering carbon dioxide in basalt by a butt well, and mine well water injected from a horizontal well reacts with liquid CO₂ injected from a vertical well, reducing water consumption for storage. In order to evaluate a fracture network modification effect and to perform quantitative characterization and fracture development degree assessment on fractures, Patent CN117633409A proposes a method for calculating seepage parameters of a shale oil and gas reservoir pressure fracture network, which can greatly improve the calculation efficiency of seepage parameters, Patent CN116698577A proposes a quantitative evaluation method for a potential of volume fracturing to form a complex fracture network in a shale oil reservoir, and rock heterogeneity and the initial micro-fracture development degree are quantitatively evaluated by calculating differences in different minerals of a stratification and a stratification fragmentation degree. These fracture characterization and evaluation methods characterize a fracture development structure from a certain perspective, but fail to achieve multi-dimensional quantitative characterization and permeability-increasing fracturing effect evaluation on a fracture structure.

### SUMMARY

In response to the problems and needs raised above, this solution proposes a carbon dioxide storage target reservoirmodified fracture characterization and permeability-increasing effect evaluation method. Since the following technical features are adopted, the above technical purposes can be achieved, and many other technical effects are brought.

The purpose of the present invention is to propose a carbon dioxide storage target reservoirmodified fracture characterization and permeability-increasing effect evaluation method, including the following steps:
S10: exploring geological area data of a mineralization storage target reservoir, determining a proposed carbon dioxide mineralization storage target reservoir having a storage potential, determining a specific position of a supercritical carbon dioxide injection well according to storage capability assessment data. Extract a core sample of a storage rock reservoir for analyzing physical and chemical properties of the core sample during a well drilling process, and after well completion, performing geophysical logging to obtain carbon dioxide storage-related key parameters of structure, thickness and porosity of the rock reservoir;
S20: setting up an injection well structure in a storage rock reservoir according to a position of the injection well, the injection well structure including horizontal well sections and vertical well sections, the horizontal well sections being arranged in an extending manner in an extension direction of the storage rock reservoir and being arranged at intervals in both a depth direction of the storage rock reservoir and a transverse direction vertical to the depth direction, and each of the horizontal well sections being in communication with a supercritical carbon dioxide preparation system through the related vertical well sections;
S30: transporting supercritical carbon dioxide to the storage target reservoir through the injection well structure to fracture a rock mass, constructing monitoring wells to perform microseismic monitoring, analyzing a microseismic waveform signal for performing fracture source locating and determining a newly formed fracture accumulation area, and obtaining spatial scale parameters of a fracture volume, a fracture surface normal direction and a fracture displacement movement direction through seismic source mechanism inversion, thereby acquiring a situation of storage target reservoir rock mass fracture formation caused by supercritical carbon dioxide fracturing;
S40: based on fracture spatial scale information, judging a connectivity of a newly formed fracture from three dimensions of a fracture source spacing, a fracture size and a fracture orientation, determining a fracture density by utilizing three-dimensional volume number density of locating points, characterizing a rock mass permeation capability by solving a maximum eigenvalue and a corresponding eigenvector based on a fracture damage tensor, and quantitatively characterizing a fracture network obtained by fracturing and permeability-increasing modification of the storage target reservoir rock mass from three dimensions of connectivity, density and permeability of the target reservoir rock mass;
S50: obtaining fracture characterization parameters in real time in a storage target reservoir fracturing process, instantly assessing a permeability-increasing effect of a fracture network structure, formulating a fracture network permeability-increasing modification plan, performing monitoring and re-evaluation for a further fracture network modification process, to achieve storage target reservoir fracture network modification effect maximization, and using the obtained supercritical carbon dioxide injection parameters and the injection well structure as best parameters for other storage target reservoir fracture network permeability-increasing modifications, monitoring and evaluating a modification process and making a corresponding adjustment to achieve permeability-increasing effect optimization.

In one example of the present invention, in step S10, determining the proposed carbon dioxide mineralization storage target reservoir with a storage potential includes:
performing storage rock reservoir mineralization capability assessment on a proposed carbon dioxide mineralization area having a storage potential, wherein an expression of a mineralization capability F of the storage rock reservoir is:
F=ρ_{c}Sh(f₁+f₂); in the expression, ρ_{c} is the density of the storage rock reservoir, S is the distribution area of the storage rock reservoir, h is the average thickness of the storage rock reservoir, f₁ is the maximum capability of a pore surface in a unit volume rock mass that can contact carbon dioxide to undergo a mineralization reaction, and its weight is w₁; f₂ is the maximum capability of a rock mass that can undergo carbon replacement, and its weight is w₂;
therein, specific expressions of f₁ and f₂ are:

$${f}_{1} = {w}_{1} φ sm$$

$${f}_{2} = {w}_{2} ( 1 − φ ) {m}^{′} ;$$

in the expressions, φ is a porosity, s is a pore reaction surface area, m is a maximum amount of a unit area of stored carbon dioxide, and m′ is a storage amount of calcium, magnesium and iron reaction minerals that can achieve carbon replacement in a unit volume of rock mass.

In one example of the present invention, in step S20, a plurality of branch well sections are also arranged on each of the horizontal well sections, and the plurality of branch well sections are arranged at intervals along both a circumferential direction and an extension direction of the horizontal well section; therein, an included angle between the extension direction of each of the branch well sections and a direction of the horizontal well section from one side of the vertical well section to one side away from the vertical well section is an acute included angle;
wherein on the branch well section, in the plurality of branch well sections arranged at intervals in the extension direction thereof, projections of two adjacent branch well sections on a plane vertical to the horizontal well section do not overlap with each other.

In one example of the present invention, in step S30, obtaining the spatial scale parameters of the fracture volume, the fracture surface normal direction and the fracture displacement movement direction through seismic source mechanism inversion includes the following steps:
S31: determining a position of a fracture seismic source point, wherein an expression of theoretical normal displacement u′ᵣ (x, t) of a fracture seismic source is:

$${u}_{r}^{i} ( x , t ) = \frac{{γ}_{i} {γ}_{k} {γ}_{l}}{4 πρ {c}_{p}^{3}} \frac{1}{r} {\dot{M}}_{kl} ( {x}_{0} , t - \frac{r}{{c}_{p}} ) ;$$

in the expression, cₚ is p-wave velocity, ρ is rock mass density, r, γ are respectively direct spatial distance and direction cosine of a fracture seismic source and a sensor observation position, and \dot{M}ₖₗ is a time derivative of a moment tensor; x₀ is a seismic source position vector, and t is arrival time of p-wave received by a sensor; i, l, k represents three direction component subscripts of a three-dimensional coordinate system;
S32: through a minimum error between theoretical normal displacement and measured displacement of the fracture seismic source, namely a minimum value of an objective function E, further obtaining the moment tensor Mₖₗ, wherein an expression of the objective function E is:

$$E = {\sum }_{i = 1}^{N} [ {u}_{m}^{i} − {u}_{r}^{i} ( {M}_{k l} , x ) ] ;$$

wherein N is a number of sensors used for monitoring normal displacement data, uⁱₘ is measured normal displacement at the sensor, and uⁱᵣ (Mₖₗ, x) is theoretical normal displacement of the fracture seismic source obtained from the above expression;
S33: determining the fracture volume, the rupture surface normal direction and the fracture displacement movement direction, with a calculation formula concerning the moment tensor as follows:

$$Δ V = \frac{( {M}_{1} − {M}_{3} )}{2 μ}$$

$$θ = \frac{1}{2} arc cos ( \frac{2 μ {M}_{2}}{λ ( {M}_{1} − {M}_{3} )} )$$

$$n = ( cos θ , 0 , \pm sin θ ) ; d = ( cos θ , 0 , ∓ sin θ ) ;$$

wherein M₁, M₂, M₃ are eigenvalues of the moment tensor Mₖₗ, λ and μ are Lame constants; n and dare a normal vector and a movement vector of a fracture surface.

In one example of the present invention, in step S30, constructing the monitoring wells to perform microseismic monitoring includes the following steps:
deploying the monitoring wells around the modified target reservoir and arranging to cover an object monitoring area, with the monitoring wells being deep to an upper part of a lower storage overlying reservoir, and a radius of the monitoring wells from a horizontal well array meeting minimum requirements for data signal station reception;
wherein a difference in distances between a lowest frequency acoustic signal released by a farthest fracture seismic source and a nearest data collection station as well as a farthest data collection station should meet a distance of one wavelength to a minimum extent;

deploying waveform signal collection low-frequency detectors at different depths of the monitoring wells, making inclination angles between the detectors and a target reservoir fracturing position to be in an interval of 15°-50°, disposing first detectors according to position and inclination angle requirements of the monitoring wells, and arranging, installing and disposing the other detectors at identical intervals from top to bottom, to form a stereoscopic monitoring array for real-time monitoring of a fracturing situation of the storage target reservoir rock mass.

In one example of the present invention, in step S40, judging the connectivity of a newly formed fracture from the three dimensions of fracture source spacing, fracture size and fracture orientation based on fracture spatial scale information includes the following steps:
S41: taking a certain seismic source point i namely a newly formed fracture, a normal direction of a crack surface being n, a movement direction of the crack surface being d, and with the seismic source point i as a center of a sphere, forming a connectivity assessment subunit within X radius in space, its subunit volume being V=4/3 πX³; a nearest seismic source point being j, a distance between the seismic source points i and j being Dᵢⱼ, fracture volume of the seismic source i being Vᵢ, a normal included angle between the seismic source points i and j being α, and a normal included angle between the seismic source points i and j being β;
S42: if the seismic source distance Dᵢⱼ≤εX, ε being a distance coefficient, considering that a seismic source point distance is nearer, and fracture connectivityy is better, and deciding the fracture connectiity as connectivity I, and that there is a capability for full mineralization;
S43: if the seismic source distance Dᵢⱼ>εX, judging a size relationship between the fracture volume Vi of the seismis source i and ξV, wherein if Vᵢ≥ξV, ξ being a volume coefficient, and the seismic source fracture size is larger, considering that the fracture volume is larger; if Vᵢ<ξV and the seismic source fracture size is smaller, consering that the fracture volume is smaller.

In one example of the present invention, in step S43, judging the size relationship between the fracture volume Vᵢ of the seismic source i and ξV specifically includes the following steps:
S431: in case that the fracture volume of the seismic source i is Vᵢ≥ξV, if a normal included angle between the seismic source points i and j is αᵢⱼ>α, or if a normal included angle between the seismic source points i and j is βᵢⱼ>β, considering that an included angle of a fracture surface is larger, a fracture has a potential to extend and connect from a tail part, the fracture connectivity is better, and there is a capability for full mineralization, and deciding the fracture connectivity as connectivity I; if the normal included angle between the seismic source points i and j is αᵢⱼ≤α, or the normal included angle between the seismic source points i and j is βᵢⱼ≤β, considering that the included angle of the fracture surface is smaller, and the fracture connectivity is general, and deciding the fracture connectivity as connectivityII;
S432: in case that the fracture volume of the seismic source i is Vᵢ<ξV, if the normal included angle between the seismic source points i and j is αᵢⱼ>α, or if the normal included angle between the seismic source points i and j is βᵢⱼ>β, considering that the degree of fracture volume is not high, but if the included angle of the fracture surface is larger, deciding that the fracture connectivity is general, namely connectivityII; if the normal included angle between the seismic source points i and j is αᵢⱼ≤α, or the normal included angle between the seismic points i and j is βᵢⱼβ, considering that a fracture volume degree is not high, the included angle of the fracture surface is smaller, and the fracture connectivity is poor, and deciding the fracture connectivity as connectivityIII.

In one example of the present invention, in step S40, determining the fracture density by utilizing the three-dimensional volume number density of the locating points includes the following steps:
taking a certain seismic source point i′, and with the seismic source point i′ as a center of a sphere, forming a density assessment subunit within radius X′ in space, its subunit volume being V′=4/3 πX′³; if a location number in the subunit volume V′ is Nᵢ, volume number density is nᵢ′=Nᵢ′/V′; when the volume number density nᵢ′ of the locating points is greater, affirming that a fracture density is higher; if the volume number density ni′ of the locating points is smaller, basically affirming that a fracture density is lower.

In one example of the present invention, in step S40, based on the fracture damage tensor, solving the maximum eigenvalue and the corresponding eigenvector to characterize the rock mass permeation capability specifically includes the following steps:
S401: determining a crack damage tensor, the crack damage tensor representing an overall damage degree of a certain volume of rock mass, and being defined by a crack size and direction as:

$${ω}_{kl} - \frac{1}{V} {\sum }_{i = 1}^{N} {( {A}^{′} )}^{\frac{3}{2}} {n}_{k}^{i} {n}_{l}^{i} ;$$

wherein ωₖₗ is a damage tensor in a unit volume V of a seismic source point i, N is a number of active cracks in the unit volume, that is, the location number in the unit volume, Aⁱ is an area of an i-th crack surface, and nⁱ is a normal vector of an i-th crack;
S402: solving an eigenvalue and an eigenvector, the eigenvalue and the eigenvector of the damage tensor ωₖₗ in the unit volume V of the seismic source point i being defined as:
(ω₀δₖₗ−ωₖₗ)Uᵢ=0; therein, ω₀ is an eigenvalue of the damage tensor, δₖₗ is a unit matrix, and Uᵢ is an eigenvector of ωₖₗ corresponding to the eigenvalue ω₀; letting a characteristic polynomial |ω₀δkl−ωₖₗ=0, a maximum eigenvalue ωₘ and a corresponding eigenvector Um are solved;
S403: quantitatively characterizing the permeability, a rock mass damage degree being a crack development degree, a fracture development situation greatly affecting a change in a permeation rate, and in case of not considering chemical reactions and changes in external physical conditions, fracture damage being a decisive factor affecting the permeability of the storage target reservoir rock mass; wherein the maximum eigenvalue ωₘ of the damage tensor ωₖₗ represents a maximum damage degree, a maximum eigenvalue of a damage tensor in a certain area is used instead to characterize the permeability, and a corresponding eigenvector of the maximum eigenvalue is a dominant permeation direction; ωₘ is defined as a function of the permeation rate k:
ωₘ=ηk; therein, η is a correlation coefficient between the maximum eigenvalue ωₘ of the damage tensor and the permeation rate k.

In one example of the present invention, in step S50, assessing the permeability-increasing effect of the fracture network structure, and formulating the fracture network permeability-increasing modification plan includes the following steps:
within a time period requiring assessment, using an assessment subunit as a unit, and according to an actual corresponding situation, from strong to weak degree, dividing the connectivity into three levels, dividing the density into two levels, dividing the permeability into three levels, and respectively assigning them with 3, 2 and 1 points from strong to weak, wherein when the density is divided into two levels, a strong level is assigned with 3, and a weak level is assigned with 2, and as monitoring and evaluation data increases and an actual geological situation is used in combination, level rating and assigned score values will be subsequently divided and adjusted more finely;
according to an evaluation of the permeability-increasing effect of the fracture network structure, a score is assigned between 9 and 4, and a fracture network permeability-increasing modification plan is formulated to increase correspondingly;
when evaluation values are 9 and 8, a target reservoir rock mass modification effect is better, and a modification is not needed; when the evaluation values are 7 and 6, the target reservoir rock mass modification effect is moderate, and injection pressure and speed in carbon dioxide storage injection parameters are adjusted; when the evaluation values are 5 and 4, the target reservoir rock mass modification effect is poor, the injection pressure and speed are increased, the density of carbon dioxide liquid is changed, a pH value of the injection liquid is adjusted, and dual physical and chemical methods are used to perform permeability-increasing modification on a target reservoir fracture network.

The best embodiments for implementing the present invention will be described in more detail below with reference to the accompanying drawings so that the features and advantages of the present invention can be easily understood.

### BRIEF DESCRIPTION OF DRAWINGS

In order to more clearly illustrate the technical solution of the embodiment of the present invention, the drawings of the embodiment of the present invention will be briefly introduced below. Among them, the drawings are only used to show some embodiments of the present invention, but not to limit all embodiments of the present invention thereto.

FIG. 1 is a structural schematic diagram of carbon dioxide injected in a storage target reservoir according to an embodiment of the present invention;

FIG. 2 is a structural schematic diagram of an injection well structure provided on a storage target reservoir according to an embodiment of the present invention;

FIG. 3 is a flow chart of a carbon dioxide storage target reservoirmodified fracture characterization and permeability-increasing effect evaluation method according to an embodiment of the present invention;

FIG. 4 is a flow chart of judging a connectivity degree of a newly formed fracture according to an embodiment of the present invention.

### THE LIST OF REFERENCE NUMERALS IN THE DRAWINGS

Injection well structure 110;
Horizontal well section 111;
Vertical well section 112;
Branch well section 113;
Supercritical carbon dioxide preparation system 120;
Extension direction X;
Depth direction Y;
Transverse direction Z.

### DESCRIPTION OF EMBODIMENTS

In order to make the purpose, technical solutions and advantages of the present invention clearer, the technical solutions in the embodiments of the present invention are described clearly and completely below in conjunction with the drawings in the specific embodiments of the present invention. Identical reference numerals in the drawings represent identical components. It needs to be noted that the described embodiments are part of the embodiments of the present invention, not all of the embodiments. On the basis of the described embodiments of the present invention, all other embodiments obtained by those of ordinary skill in the art without exerting creative efforts should fall within the scope of protection of the present invention.

Unless otherwise defined, technical terms or scientific terms used herein should be understood by persons with ordinary skills in the field to which the present invention belongs. “First”, “second” and similar words used in the patent application specification and claims of the present invention do not indicate any order, quantity or importance, but are only used to distinguish different components. Likewise, words such as “a” or “one” do not necessarily indicate a quantitative limitation. Words such as “include” or “contain” mean that elements or things appearing ahead of the word include elements or things listed behind the word and their equivalents, without excluding other elements or things. Words such as “connect” or “connected” are not limited to physical or mechanical connections, but may include electrical connections, whether direct or indirect. “Up”, “down”, “left”, “right”, etc. are only used to express relative positional relationships. After the absolute position of a described object changes, the relative positional relationship may also change correspondingly.

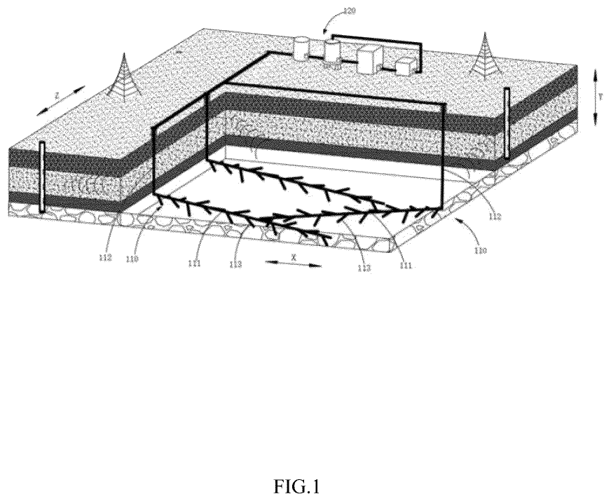

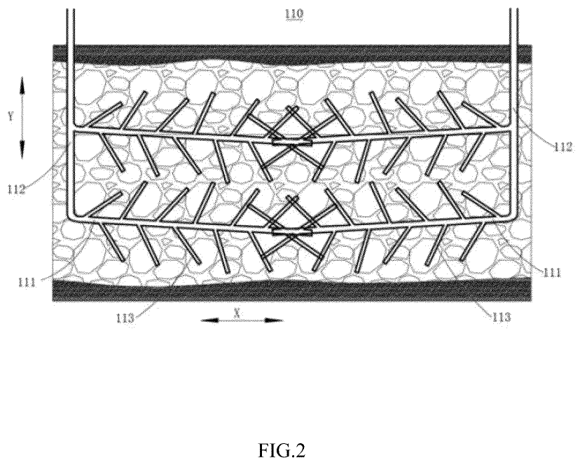

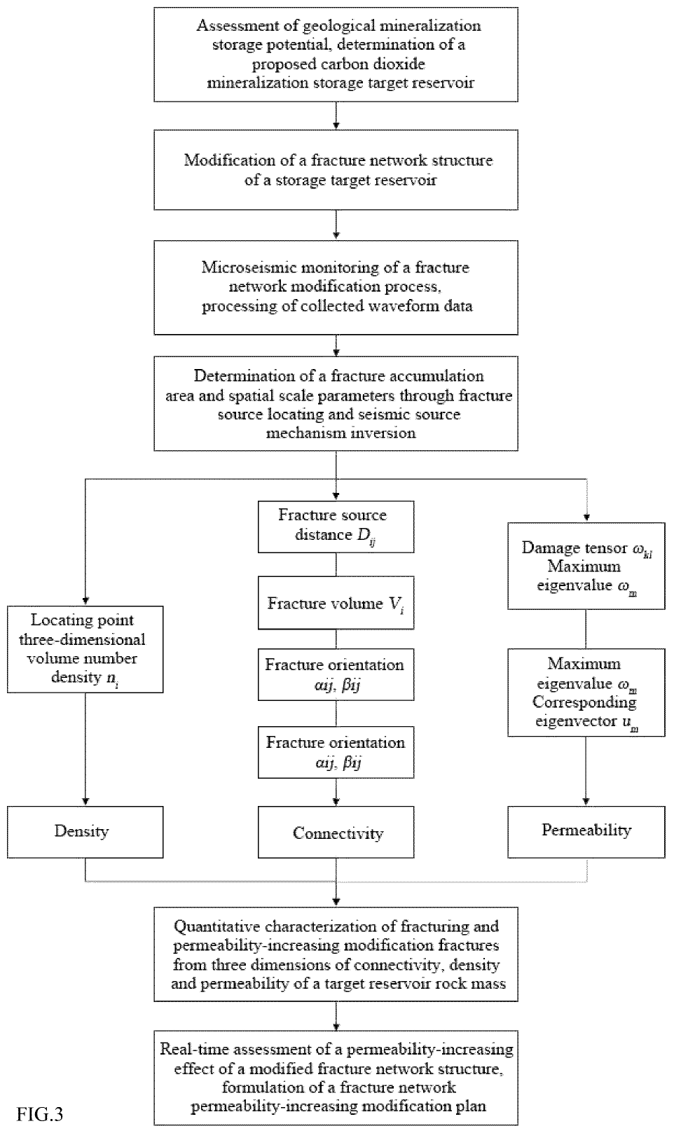

A carbon dioxide storage target reservoirmodified fracture characterization and permeability-increasing effect evaluation method according to a first aspect of the present invention, as shown in FIG. 1 to FIG. 3, includes the following steps:
S10: exploring geological area data of a mineralization storage target reservoir, determining a proposed carbon dioxide mineralization storage target reservoir having a storage potential, determining a specific position of a supercritical carbon dioxide injection well according to storage capability assessment data, extracting a core sample of a storage rock reservoir for analyzing physical and chemical properties of the core sample during a well drilling process, and after well completion, performing geophysical logging to obtain carbon dioxide storage-related key parameters of structure, thickness and porosity of the rock reservoir;
S20: setting up an injection well structure 110 in a storage rock reservoir according to a position of the injection well, the injection well structure 110 including horizontal well sections 111 and vertical well sections 112, the horizontal well sections 111 being arranged in an extending manner in an extension direction X of the storage rock reservoir and being arranged at intervals in both a depth direction Y of the storage rock reservoir and a transverse direction Z vertical to the depth direction Y, and each of the horizontal well sections 111 being in communication with a supercritical carbon dioxide preparation system 120 through the related vertical well sections 112; it needs to be noted that the extension direction X is an extension direction of storage extension, which is not necessarily vertical to the transverse direction Z and the depth direction Y, and may coincide with a horizontal direction, and may also form an included angle with the horizontal direction, wherein the horizontal direction is vertical to the transverse direction to the transverse direction Z and the depth direction Y;
S30: transporting supercritical carbon dioxide to the storage target reservoir through the injection well structure 110 to fracture a rock mass, constructing monitoring wells to perform microseismic monitoring, analyzing a microseismic waveform signal for performing fracture source locating and determining a newly formed fracture accumulation area, and obtaining spatial scale parameters of a fracture volume, a fracture surface normal direction and a fracture displacement movement direction through seismic source mechanism inversion, thereby acquiring a situation of storage target reservoir rock mass fracture formation caused by supercritical carbon dioxide fracturing;
S40: based on fracture spatial scale information, judging a connectivity of a newly formed fracture from three dimensions of a fracture source spacing, a fracture size and a fracture orientation, determining a fracture density by utilizing three-dimensional volume number density of locating points, characterizing a rock mass permeation capability by solving a maximum eigenvalue and a corresponding eigenvector based on a fracture damage tensor, and quantitatively characterizing a fracture network obtained by fracturing and permeability-increasing modification of the storage target reservoir rock mass from three dimensions of connectivity, density and permeability of the target reservoir rock mass;
S50: obtaining fracture characterization parameters in real time in a storage target reservoir fracturing process, instantly assessing a permeability-increasing effect of a fracture network structure, formulating a fracture network permeability-increasing modification plan, performing monitoring and re-evaluation for a further fracture network modification process, to achieve storage target reservoir fracture network modification effect maximization, and using the obtained supercritical carbon dioxide injection parameters and the injection well structure 110 as best parameters for other storage target reservoir fracture network permeability-increasing modifications, monitoring and evaluating a modification process and making a corresponding adjustment to achieve permeability-increasing effect optimization.

In the assessment of a carbon dioxide mineralization storage potential, this evaluation method considers the impact of porosity on rock mass mineralization, and performs storage potential assessment from two aspects of pore contact mineralization reaction potential and mineral replacement capability. This method changes a single storage mineralization potential evaluation mode, makes the assessment of carbon dioxide mineralization storage potential more accurate, and is of practical significance for how to formulate a storage target reservoir fracture network modification plan.

In the modification of the fracture network structure of the storage target reservoir, this evaluation method adopts a multi-reservoir and multi-branch horizontal well modification method, takes an actual structure of a storage geological reservoir into account, makes full use of a space of a proposed storage target reservoir, and significantly increases a contact area between supercritical carbon dioxide and a mineralization storage rock mass.

In storage rock mass fracture characterization, this evaluation method obtains a spatial position and scale parameters of a fracture seismic source based on microseismic monitoring waveform data locating and seismic source mechanism inversion, and provides a fracture connectivity and density judgment criteria. Permeability is represented based on a maximum eigenvalue of a fracture damage tensor, and an eigenvector corresponding to the maximum eigenvalue is defined as a dominant direction of permeation. This method provides a reference for a method of indirectly assessing rock mass permeability.

This evaluation method continuously implements a real-time dynamic control mode of modifying, monitoring and re-evaluating the storage target reservoir in the assessment of a fracture network permeation effect and the formulation of a modification plan, so as to achieve the maximization of the fracture network modification effect of the storage target reservoir. Procedures and flows, such as fracture characterization, effect assessment and modification plans in this method are not only suitable for permeability-increasing modification of a carbon dioxide mineralization storage target reservoir, but also can provide a reference to judge a mineralization effect for rock mass structure changes of pore generation, mineral deposition, etc. in a mineralization reaction process.

In one example of the present invention, in step S10, determining the proposed carbon dioxide mineralization storage target reservoir with a storage potential includes:
performing storage rock reservoir mineralization capability assessment on a proposed carbon dioxide mineralization area with a storage potential, wherein an expression of mineralization capability F of a storage rock reservoir is:
F=ρ_{c}Sh(f₁+f₂); in the expression, ρ_{c} is the density of the storage rock reservoir, S is the distribution area of the storage rock reservoir, h is the average thickness of the storage rock reservoir, f₁ is the maximum capability of a pore surface in a unit volume of rock mass that can contact carbon dioxide to undergo a mineralization reaction, and its weight is w₁; f₂ is a maximum capability of a rock mass that can undergo carbon replacement, and its weight is w₂;
wherein specific expressions of f₁ and f₂ are:

$${f}_{1} = {w}_{1} φ sm$$

$${f}_{2} = {w}_{2} ( 1 − φ ) {m}^{′} ;$$

in the expressions, φ is a porosity, s is a pore reaction surface area, m is a maximum amount of a unit area of stored carbon dioxide, and m′ is a storage amount of calcium, magnesium and iron reaction minerals that can achieve carbon replacement in a unit volume of rock mass.

In one example of the present invention, in step S20, a plurality of branch well sections 113 are also arranged on each of the horizontal well sections 111, and the plurality of branch well sections 113 are arranged at intervals along both a circumferential direction and an extension direction X of the horizontal well section 111; therein, an included angle between the extension direction X of each of the branch well sections 113 and a direction of the horizontal well section 111 from one side of the vertical well section 112 to one side away from the vertical well section 112 is an acute included angle;
specifically, the injection well structure 110 is a three-opening well body structure, and its construction process includes three steps. In the first step, a casing pipe is used to cover a surface layer below an open hole wall to an upper storage overlying reservoir. In the second step, a casing pipe is lowered to a roof of an object storage rock reservoir. In the third step, horizontal drilling is performed for open hole well completion. The length of the horizontal well section 111 of the injection well structure 110 is 1000-1300 m. The directions of injecting supercritical carbon dioxide into transversely adjacent horizontal well sections 111 in the target reservoir are opposite. The initial position of the injection well of one horizontal well section 111 is 20-30 m away from a tail end of one adjacent horizontal well section 111 in a transverse direction Z. The spacing between branch well sections 113 on the same horizontal well section 111 is 10-15 m, the branch well section 113 and the horizontal well section 111 form an included angle of 45-60°, and tilt upward and downward in sequence with the horizontal well section 111 as a baseline. The spacing between tail parts of the branch well sections 113 of different horizontal well sections 111 is 5-10 m.

Preferably, the casing pipe used in a wellhole uses a carbon steel material that prevents carbon dioxide corrosion. Casing pipe corrosion and carbonate nodule situations are regularly checked through monitoring corrosion coupons and the cased hole to ensure that the casing pipe can normally transport carbon dioxide storage liquid.

In one example of the present invention, on the horizontal well section 111, among the plurality of branch well sections 113 arranged at intervals in the extension direction X thereof, projections of two adjacent branch well sections 113 on a plane vertical to the horizontal well section 111 do not overlap with each other; this allows the two adjacent branch well sections 113 to minimize an overlapping range that can be covered by the two adjacent branch well sections when supercritical carbon dioxide is injected, and greatly increases a contact area between the supercritical carbon dioxide and a mineralization storage rock mass.

In one example of the present invention, in step S30, obtaining the spatial scale parameters of the fracture volume, the fracture surface normal direction and the fracture displacement movement direction through seismic source mechanism inversion includes the following steps:
S31: determining a position of a fracture seismic source point, wherein an expression of a theoretical normal displacement uⁱᵣ (x, t) of a fracture seismic source is:

$${u}_{r}^{i} ( x , t ) = \frac{{γ}_{i} {γ}_{k} {γ}_{l}}{4 πρ {c}_{p}^{3}} \frac{1}{r} {\dot{M}}_{kl} ( {x}_{0} , t - \frac{r}{{c}_{p}} ) ;$$

in the expression, cₚ is a p-wave velocity, ρ is a rock mass density, r and γ are respectively direct spatial distance and direction cosines of a fracture seismic source and a sensor observation position, \dot{M}ₖₗ is a time derivative of a moment tensor; x₀ is a seismic source position vector, and/is arrival time of p-wave received by a sensor; i, l, k represent three direction component subscripts of a three-dimensional coordinate system;
S32: through a minimum error between theoretical normal displacement and measured displacement of the fracture seismic source, namely a minimum value of an objective function E, further obtaining the moment tensor Mₖₗ, wherein an expression of the objective function E is:

$$E = {\sum }_{i = 1}^{N} [ {u}_{m}^{i} − {u}_{r}^{i} ( {M}_{k l} , x ) ] ;$$

wherein N is a number of sensors used for monitoring normal displacement data, uⁱm is a measured normal displacement at the sensor, and wⁱᵣ(Mₖₗ, x) is theoretical normal displacement of the fracture seismic source obtained from the above expression;
S33: determining the fracture volume, the fracture surface normal direction and the fracture displacement movement direction, with a calculation formula concerning the moment tensor as follows:

$$Δ V = \frac{( {M}_{1} − {M}_{3} )}{2 μ}$$

$$θ = \frac{1}{2} arc cos ( \frac{2 μ {M}_{2}}{λ ( {M}_{1} − {M}_{3} )} )$$

$$n = ( cos θ , 0 , \pm sin θ ) ; d = ( cos θ , 0 , ∓ sin θ ) ;$$

wherein M₁, M₂, M₃ are eigenvalues of the moment tensor Mₖₗ, λ and μ are Lame constants; n and d are a normal vector and a movement vector of a fracture surface.

In one example of the present invention, in step S30, constructing the monitoring wells to perform microseismic monitoring includes the following steps:
deploying the monitoring wells around the modified target reservoir and arranging to cover an object monitoring area, with the monitoring wells being deep to an upper part of a lower storage overlying reservoir, and a radius of the monitoring wells from a horizontal well array meeting minimum requirements for data signal station reception;
wherein a difference in distances between a lowest frequency acoustic signal released by a farthest fracture seismic source and a nearest data collection station as well as a farthest data collection station should meet a distance of one wavelength to a minimum extent;
deploying waveform signal collection low-frequency detectors at different depths of the monitoring wells, making inclination angles between the detectors and a target reservoir fracturing position to be in an interval of 15°-50°, disposing first detectors according to position and inclination angle requirements of the monitoring wells, and arranging, installing and disposing the other detectors at identical intervals from top to bottom, to form a stereoscopic monitoring array for real-time monitoring of a fracturing situation of the storage target reservoir rock mass.

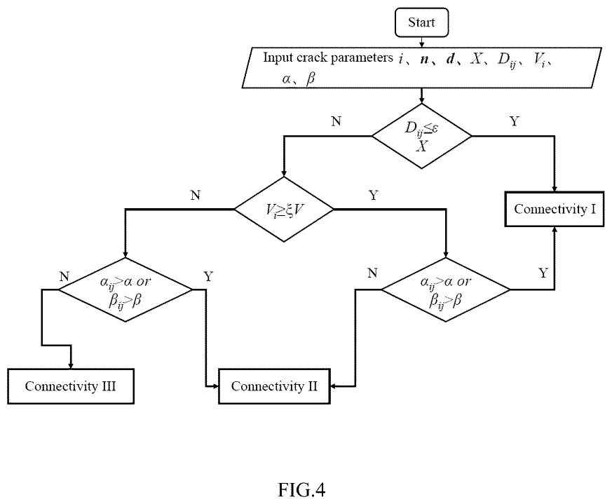

In one example of the present invention, in step S40, as shown in FIG. 4, judging the connectivity of the newly formed fracture from the three dimensions of fracture source spacing, fracture size and fracture orientation based on fracture spatial scale information includes the following steps:
S41: taking a certain seismic source point i namely a newly formed fracture, a normal direction of a crack surface being n, a movement direction of the crack surface being d, and with the seismic source point i as a center of a sphere, forming a connectivity assessment subunit within X radius in space, its subunit volume being V=4/3 πX³; a nearest seismic source point being j, a distance between the seismic source points i and j being Dᵢⱼ, fracture volume of the seismic source i being Vᵢ, a normal included angle between the seismic source points i and j being α, and a normal included angle between the seismic source points i and j being β;
S42: if the seismic source distance D_{if}≤εX (ε is a distance coefficient, its value range is defined according to the strictness of assessment, and a preliminary value is ε<⅓), considering that a seismic source point distance is nearer, and fracture connectivity is better, and deciding the fracture connectivity as connectivity I, and that there is a capability for full mineralization in a certain range;
S43: if the seismic source distance Dᵢⱼ>εX, judging a size relationship between the fracture volume Vᵢ of the seismic source i and ξV, wherein if Vᵢ≥ξV (ξ is a volume coefficient, its value range is defined according to the strictness of assessment, and a preliminary value is ξ<0.2), and the seismic source fracture size is larger, considering that the fracture volume is larger; if Vᵢ<ξV, and the seismic source fracture size is smaller, considering that the fracture volume is smaller.

In one example of the present invention, in step S43, judging the size relationship between the fracture volume Vᵢ of the seismic source i and ξV specifically includes the following steps:
S431: in case that the fracture volume of the seismic source i is Vᵢ≥ξV, if a normal included angle between the seismic source points i and j is αᵢⱼ>α, or if a normal included angle between the seismic source points i and j is βᵢⱼ>β (a value range of α and β is defined according to the strictness of assessment, and a preliminary value is) 30-45°), considering that an included angle of a fracture surface is larger, a fracture has a potential to extend and connect from a tail part, the fracture connectivity is better, and there is still a capability for full mineralization within a certain range, and deciding the fracture connectivity as connectivity I; if the normal included angle between the seismic source points i and j is αᵢⱼ≤α, or the normal included angle between the seismic source points i and j is βᵢⱼ≤β, considering that the included angle of the fracture surface is smaller, and the fracture connectivity is general, and deciding the fracture connectivity as connectivity II;
S432: in case that the fracture volume of the seismic source i is Vᵢ<ξV, if the normal included angle between the seismic source points i and j is αᵢⱼ>α, or if the normal included angle between the seismic source points i and j is βᵢⱼ>β, considering that the degree of fracture volume is not high, but if the included angle of the fracture surface is larger, deciding that the fracture connectivity is general, namely connectivity II; if the normal included angle between the seismic source points i and j is αᵢⱼ≤α, or the normal included angle between the seismic source points i and j is βᵢⱼ≤β, considering that a fracture volume degree is not high, the included angle of the fracture surface is smaller, and the fracture connectivity is poor, and deciding the fracture connectivity as connectivity III.

The fracture connectivity is divided into three levels: I, II and III, the connectivity decreases in sequence, and the connectivity of the newly formed fracture in the rock mass fractured by supercritical carbon dioxide is assessed as better, general and poor.

In one example of the present invention, in step S40, based on the fracture damage tensor, solving the maximum eigenvalue and the corresponding eigenvector to characterize the rock mass permeation capability specifically includes the following steps:
S401: determining a crack damage tensor, the crack damage tensor representing an overall damage degree of a certain volume of rock mass, and being defined by a crack size and direction as:

$${ω}_{kl} - \frac{1}{V} {\sum }_{i = 1}^{N} {( {A}^{′} )}^{\frac{3}{2}} {n}_{k}^{i} {n}_{l}^{i} ;$$

wherein ωₖₗ is a damage tensor in a unit volume V of a seismic source point i, N is a number of active cracks in the unit volume, that is, the location number in the unit volume, Aⁱ is the area of an i-th crack surface, and nⁱ is a normal vector of an i-th crack;
S402: solving an eigenvalue and an eigenvector, the eigenvalue and the eigenvector of the damage tensor ωₖₗ in the unit volume V of the seismic source point i being defined as:
(ω₀δₖₗ−ωₖₗ)Uᵢ=0; wherein ω₀ is an eigenvalue of the damage tensor, δₖₗ is a unit matrix, and Uᵢ is an eigenvector of ωₖₗ corresponding to the eigenvalue ω₀; letting a characteristic polynomial |ω₀δₖₗ−ωₖₗ|=0, a maximum eigenvalue ωₘ and a corresponding eigenvector Uₘ are solved;
S403: quantitatively characterizing the permeability, a rock mass damage degree being a crack development degree, a fracture development situation greatly affecting a change in a permeation rate, and in case of not considering chemical reactions and changes in external physical conditions, it being basically considered that fracture damage is a decisive factor affecting the permeability of the storage target reservoir rock mass; wherein the maximum eigenvalue ωₘ of the damage tensor wow represents a maximum damage degree, a maximum eigenvalue of a damage tensor in a certain area is used instead to characterize the permeability, and a corresponding eigenvector of the maximum eigenvalue is a dominant permeation direction; ωₘ is defined as a function of the permeation rate k:
ωₘ=ηk; therein, η is a correlation coefficient between the maximum eigenvalue ωₘ of the damage tensor and the permeation rate k.

In one example of the present invention, in step S40, determining the fracture density by utilizing the three-dimensional volume number density of the locating points includes the following steps:
taking a certain seismic source point i′, and with the seismic source point i′ as a center of a sphere, forming a density assessment subunit within radius X′in space, its subunit volume being V′=4/3 πX′³; if a location number in the subunit volume V′ is Nᵢ′, volume number density is nᵢ′=Nᵢ′,/V′; when the volume number density nᵢ′ of the locating points is greater, affirming that a fracture density is higher; if the volume number density nᵢ′ of the locating points is smaller, basically affirming that a fracture density is lower.

In one example of the present invention, in step S50, assessing the permeability-increasing effect of the fracture network structure, and formulating the fracture network permeability-increasing modification plan includes the following steps:
within a time period requiring assessment, using an assessment subunit as a unit, and according to an actual corresponding situation, from strong to weak degree, dividing the connectivity into three levels, dividing the density into two levels, dividing the permeability into three levels, and respectively assigning them with 3, 2 and 1 points from strong to weak (when the density is divided into two levels, a strong level is assigned with 3, and a weak level is assigned with 2), and as monitoring and evaluation data increases and an actual geological situation is used in combination, level rating and assigned score values will be subsequently divided and adjusted more finely;
according to an evaluation of the permeability-increasing effect of the fracture network structure, a score is assigned between 9 and 4, and a fracture network permeability-increasing modification plan is formulated to increase correspondingly;
when evaluation values are 9 and 8, a target reservoir rock mass modification effect is better, and modification is not needed; when the evaluation values are 7 and 6, the target reservoir rock mass modification effect is moderate, and carbon dioxide storage injection parameters of injection pressure, speed, etc. are adjusted; when the evaluation values are 5 and 4, the target reservoir rock mass modification effect is poor, injection pressure and speed are increased, the density of carbon dioxide liquid is changed, a pH value of the injection liquid is adjusted, and dual physical and chemical methods are used to perform permeability-increasing modification on a target reservoir fracture network.

A CO₂ storage target reservoirmodified fracture characterization and permeability-increasing effect evaluation system according to a second aspect of the present invention includes:
a storage potential assessment unit, configured to be used for exploring geological area data of a mineralization storage target reservoir, determining a proposed carbon dioxide mineralization storage target reservoir with storage potential, determining a specific position of a supercritical carbon dioxide injection well according to storage capability assessment data, extracting a core sample of a storage rock reservoir and analyzing physical and chemical properties of the core sample during a well drilling process, and after well completion, performing geophysical logging on the well to obtain carbon dioxide storage-related key parameters of the structure, thickness and porosity of the rock reservoir;
a rock reservoir fracture network modification unit, configured to be used for setting up an injection well structure 110 in a storage rock reservoir according to a position of the injection well, the injection well structure 110 including horizontal well sections 111 and vertical well sections 112, the horizontal well sections 111 being arranged in an extending manner in an extension direction X of the storage rock reservoir and being arranged at intervals in both a depth direction Y of the storage rock reservoir and a transverse direction Z vertical to the depth direction Y, and each of the horizontal well sections 111 being in communication with a supercritical carbon dioxide preparation system 120 through the related vertical well sections 112;
a fracture monitoring unit, configured to be used for transporting supercritical carbon dioxide to the storage target reservoir through the injection well structure 110 to fracture a rock mass, constructing monitoring wells to perform microseismic monitoring, analyzing a microseismic waveform signal for performing fracture source locating and determining a newly formed fracture accumulation area, and obtaining spatial scale parameters of fracture volume, fracture surface normal direction and fracture displacement movement direction through seismic source mechanism inversion, thereby acquiring a situation of storage target reservoir rock mass fracture formation caused by supercritical carbon dioxide fracturing;
a fracture quantitative-characterization unit, configured to be used for judging the connectivity of a newly formed fracture from three dimensions of fracture source spacing, fracture size and fracture orientation based on fracture spatial scale information, determining a fracture density by utilizing three-dimensional volume number density of locating points, based on a fracture damage tensor, solving a maximum eigenvalue and a corresponding eigenvector to characterize rock mass permeation capability, and performing quantitative characterization on a fracture network obtained by fracturing and permeability-increasing modification of the storage target reservoir rock mass from three dimensions of connectivity, density and permeability of the target reservoir rock mass;
a permeability-increasing effect evaluation unit, configured to be used for obtaining fracture characterization parameters in real time in a storage target reservoir fracturing process, instantly assessing a permeability-increasing effect of a fracture network structure, formulating a fracture network permeability-increasing modification plan, performing monitoring and re-evaluation for a further fracture network modification process, to achieve storage target reservoir fracture network modification effect maximization, and using the obtained supercritical carbon dioxide injection parameters and the injection well structure 110 as best parameters for other storage target reservoir fracture network permeability-increasing modifications, monitoring and evaluating a modification process and making a corresponding adjustment to achieve permeability-increasing effect optimization

This evaluation system considers the impact of porosity on rock mass mineralization when assessing carbon dioxide mineralization storage potential, and performs storage potential assessment from two aspects of pore contact mineralization reaction potential and mineral replacement capability. This method changes a single storage mineralization potential evaluation mode, makes the assessment of carbon dioxide mineralization storage potential more accurate, and has practical significance for how to formulate a storage target reservoir fracture network modification plan.

In the modification of the storage target reservoir fracture network structure, this evaluation system adopts a multi-reservoir and multi-branch horizontal well modification method, which takes into account the actual structure of the storage geological reservoir, fully utilizes the space of the proposed storage target reservoir, and significantly enlarges the contact area between supercritical carbon dioxide and the mineralization storage rock mass.

In storage rock mass fracture characterization, this evaluation system obtains a spatial position and scale parameters of the fracture seismic source based on microseismic monitoring waveform data locating and seismic source mechanism inversion, and provides a fracture connectivity and density judgment criterion. Permeability is represented based on a maximum eigenvalue of a fracture damage tensor, and an eigenvector corresponding to the maximum eigenvalue is defined as a dominant direction of permeation. This method provides a reference for a method of indirectly assessing rock mass permeability.

This evaluation system continuously implements a real-time dynamic control mode of modification, monitoring, and re-evaluation for the storage target reservoir in fracture network permeation effect assessment and modification plan formulation, to achieve storage target reservoir fracture network modification effect maximization. Procedures and flows, such as fracture characterization, effect assessment and modification plans in this method are not only suitable for permeability-increasing modification of a carbon dioxide mineralization storage target reservoir, but also can provide a reference to judge a mineralization effect for rock mass structure changes of pore generation, mineral deposition, etc. in a mineralization reaction process.

The exemplary embodiments of the carbon dioxide storage target reservoir modified fracture characterization and permeability-increasing effect evaluation method and system proposed by the present invention are described in detail above with reference to the preferred embodiments. However, those skilled in the art can understand that under the premise of not departing from the concept of the present invention, various variations and modifications can be made to the above-mentioned specific embodiments, and various technical features and structures proposed by the present invention can be combined in various ways without exceeding the protection scope of the present invention. The protection scope of the present invention is determined by the appended claims.

What is claimed is:

1. A carbon dioxide storage target reservoirmodified fracture characterization and permeability-increasing effect evaluation method, characterized in that the carbon dioxide storage target reservoirmodified fracture characterization and permeability-increasing effect evaluation method comprises the following steps:
S10: exploring geological area data of a mineralization storage target reservoir, determining a proposed carbon dioxide mineralization storage target reservoir having a storage potential, determining a specific position of a supercritical carbon dioxide injection well according to storage capability assessment data, extracting a core sample of a storage rock reservoir for analyzing physical and chemical properties of the core sample during a well drilling process, and after well completion, performing geophysical logging to obtain carbon dioxide storage-related key parameters of structure, thickness and porosity of the rock reservoir;
S20: setting up an injection well structure (110) in the storage rock reservoir according to a position of the injection well, the injection well structure (110) including horizontal well sections (111) and vertical well sections (112), the horizontal well sections (111) being arranged in an extending manner in an extension direction (X) of the storage rock reservoir and being arranged at intervals in both a depth direction (Y) of the storage rock reservoir and a transverse direction (Z) vertical to the depth direction (Y), and each of the horizontal well sections (111) being in communication with a supercritical carbon dioxide preparation system (120) through the vertical well sections (112);
S30: transporting supercritical carbon dioxide to the storage target reservoir through the injection well structure (110) to fracture a rock mass, constructing monitoring wells to perform microseismic monitoring, analyzing a microseismic waveform signal for performing fracture source locating and determining a newly formed fracture accumulation area, and obtaining spatial scale parameters of a fracture volume, a fracture surface normal direction and a fracture displacement movement direction through seismic source mechanism inversion, thereby acquiring a situation of storage target reservoir rock mass fracture formation caused by supercritical carbon dioxide fracturing;
S40: based on fracture spatial scale information, judging a connectivity of a newly formed fracture from three dimensions of a fracture source spacing, a fracture size and a fracture orientation, determining a fracture density by utilizing three-dimensional volume number density of locating points, characterizing a rock mass permeation capability by solving a maximum eigenvalue and a corresponding eigenvector based on a fracture damage tensor, and quantitatively characterizing a fracture network obtained by fracturing and permeability-increasing modification of the storage target reservoir rock mass from three dimensions of connectivity, density and permeability of the target reservoir rock mass;
S50: obtaining fracture characterization parameters in real time in a storage target reservoir fracturing process, instantly assessing a permeability-increasing effect of a fracture network structure, formulating a fracture network permeability-increasing modification plan, performing monitoring and re-evaluation for a further fracture network modification process, to achieve storage target reservoir fracture network modification effect maximization, and using the obtained supercritical carbon dioxide injection parameters and the injection well structure (110) as best parameters for other storage target reservoir fracture network permeability-increasing modifications, monitoring and evaluating a modification process and making a corresponding adjustment to achieve permeability-increasing effect optimization.

2. The carbon dioxide storage target reservoirmodified fracture characterization and permeability-increasing effect evaluation method according to claim 1, characterized in that,
in step S10, determining the proposed carbon dioxide mineralization storage target reservoir having the storage potential comprises:
performing storage rock reservoir mineralization capability assessment on a proposed carbon dioxide mineralization area having a storage potential, wherein an expression of a mineralization capability F of the storage rock reservoir is:
F=ρ_{c}Sh(f₁+f₂); in the expression, ρ_{c} is a density of the storage rock reservoir, S is a distribution area of the storage rock reservoir, h is an average thickness of the storage rock reservoir, f₁ is a maximum capability of a pore surface in a unit volume of rock mass that can contact carbon dioxide to undergo a mineralization reaction, and its weight is w₁; f₂ is a maximum capability of a rock mass that can undergo carbon replacement, and its weight is w₂;
wherein specific expressions of f₁ and f₂ are:
$${f}_{1} = {w}_{1} φ sm$$
$${f}_{2} = {w}_{2} ( 1 − φ ) {m}^{′} ;$$
in the expressions, φ is a porosity, s is a pore reaction surface area, m is a maximum amount of a unit area of stored carbon dioxide, and m′ is a storage amount of calcium, magnesium and iron reaction minerals that can achieve carbon replacement in a unit volume of rock mass.

3. The carbon dioxide storage target reservoirmodified fracture characterization and permeability-increasing effect evaluation method according to claim 1, characterized in that,
in step S20, a plurality of branch well sections (113) are also arranged on each of the horizontal well sections (111), and the plurality of branch well sections (113) are arranged at intervals along both a circumferential direction and an extension direction (X) of the horizontal well section (111); wherein an included angle between the extension direction (X) of each of the branch well sections (113) and a direction of the horizontal well section (111) from one side of the vertical well section (112) to one side away from the vertical well section (112) is an acute included angle;
wherein on the horizontal well section (111), among the plurality of branch well sections (113) arranged at intervals in the extension direction (X) of the horizontal well section, projections of two adjacent branch well sections in the branch well sections (113) on a plane vertical to the horizontal well section (111) do not overlap with each other.

4. The carbon dioxide storage target reservoirmodified fracture characterization and permeability-increasing effect evaluation method according to claim 1, characterized in that,
in step S30, obtaining the spatial scale parameters of the fracture volume, the fracture surface normal direction and the fracture displacement movement direction through seismic source mechanism inversion comprises the following steps:
S31: determining a position of a fracture seismic source point, wherein an expression of theoretical normal displacement uⁱᵣ(x,t) of a fracture seismic source is:
$${u}_{r}^{i} ( x , t ) = \frac{{γ}_{i} {γ}_{k} {γ}_{l}}{4 πρ {c}_{p}^{3}} \frac{1}{r} {\dot{M}}_{kl} ( {x}_{0} , t - \frac{r}{{c}_{p}} ) ;$$
in the expression, cₚ is a p wave velocity, ρ is a rock mass density, r, γ are respectively direct spatial distance and direction cosines of a fracture seismic source and a sensor observation position, and \dot{M}ₖₗ is a time derivative of a moment tensor; x₀ is a seismic source position vector, and t is arrival time of p wave received by a sensor; i, l, k represent three direction component subscripts of a three-dimensional coordinate system;
S32: through a minimum error between theoretical normal displacement and measured displacement of the fracture seismic source, namely a minimum value of an objective function E, further obtaining the moment tensor Mₖₗ, wherein an expression of the objective function E is:
$$E = {\sum }_{i = 1}^{N} [ {u}_{m}^{i} − {u}_{r}^{i} ( {M}_{k l} , x ) ] ;$$
wherein N is a number of sensors used for monitoring normal displacement data, uⁱₘ is measured normal displacement at the sensor, and uⁱᵣ(Mₖₗ, x) is theoretical normal displacement of the fracture seismic source obtained from the above expression;
S33: determining the fracture volume, the fracture surface normal direction and the fracture displacement movement direction, with a calculation formula concerning the moment tensor as follows:
$$Δ V = \frac{( {M}_{1} − {M}_{3} )}{2 μ}$$
$$θ = \frac{1}{2} arc cos ( \frac{2 μ {M}_{2}}{λ ( {M}_{1} − {M}_{3} )} )$$
$$n = ( cos θ , 0 , \pm sin θ ) ; d = ( cos θ , 0 , ∓ sin θ ) ;$$
wherein M₁, M₂, M₃ are eigenvalues of the moment tensor Mₖₗ, λ and μ are Lame constants; n and d are a normal vector and a movement vector of a fracture surface.

5. The carbon dioxide storage target reservoirmodified fracture characterization and permeability-increasing effect evaluation method according to claim 1, characterized in that,
in step S30, constructing the monitoring wells to perform microseismic monitoring comprises the following steps:
deploying the monitoring wells around the modified target reservoir and arranging to cover an object monitoring area, with the monitoring wells being deep to an upper part of a lower storage overlying reservoir, and a radius of the monitoring wells from a horizontal well array meeting minimum requirements for data signal station reception;
wherein a difference in distances between a lowest frequency acoustic signal released by a farthest fracture seismic source and a nearest data collection station as well as a farthest data collection station should meet a distance of one wavelength to a minimum extent;
deploying waveform signal collection low-frequency detectors at different depths of the monitoring wells, making inclination angles between the detectors and a target reservoir fracturing position to be in an interval of 15°-50°, disposing first detectors according to position and inclination angle requirements of the monitoring wells, and arranging, installing and disposing the other detectors at identical intervals from top to bottom, to form a stereoscopic monitoring array for real-time monitoring of a fracturing situation of the storage target reservoir rock mass.

6. The carbon dioxide storage target reservoirmodified fracture characterization and permeability-increasing effect evaluation method according to claim 1, characterized in that,
in step S40, judging the connectivity of the newly formed fracture from the three dimensions of the fracture source spacing, the fracture size and the fracture orientation based on the fracture spatial scale information comprises the following steps:
S41: taking a certain seismic source point i, namely a newly formed fracture, a normal direction of a crack surface being n, a movement direction of the crack surface being d, and with the seismic source point i as a center of a sphere, forming a connectivity assessment subunit within X radius in space, its subunit volume being V=4/3 πX³; a nearest seismic source point being j, a distance between the seismic source points i and j being Dᵢⱼ, fracture volume of the seismic source i being Vᵢ, a normal included angle between the seismic source points i and j being α, and a normal included angle between the seismic source points i and j being β;
S42: if the seismic source distance D_{if}≤εX (ε is a distance coefficient, that a seismic source point distance is nearer, and fracture connectivity is better, and deciding the fracture connectivity as connectivity I, and that there is a capability for full mineralization;
S43: if the seismic source distance Dᵢⱼ>εX, judging a size relationship between the fracture volume Vᵢ of the seismic source i and ξV, wherein if Vᵢ≥ξV, ξ being a volume coefficient, and the seismic source fracture size is larger, considering that the fracture volume is larger; if Vᵢ<ξV, and the seismic source fracture size is smaller, considering that the fracture volume is smaller.

7. The carbon dioxide storage target reservoirmodified fracture characterization and permeability-increasing effect evaluation method according to claim 6, characterized in that,
in step S43, judging the size relationship between the fracture volume Vᵢ of the seismic source i and ξV specifically comprises the following steps:
S431: in case that the fracture volume of the seismic source i is Vᵢ≥ξV, if a normal included angle between the seismic source points i and j is αᵢⱼ>α, or if a normal included angle between the seismic source points i and j is βᵢⱼ>β considering that an included angle of a fracture surface is larger, a fracture has a potential to extend and connect from a tail part, the fracture connectivity is better, and there is still a capability for full mineralization, and deciding the fracture connectivity as connectivity I; if the normal included angle between the seismic source points i and j is αᵢⱼ≤α, or the normal included angle between the seismic source points i and j is βᵢⱼ≤β, considering that the included angle of the fracture surface is smaller, and the fracture connectivity is general, and deciding the fracture connectivity as connectivity II;
S432: in case that the fracture volume of the seismic source i is Vᵢ<ξV, if the normal included angle between the seismic source points i and j is αᵢⱼ>α, or if the normal included angle between the seismic source points i and j is βᵢⱼ>β, considering that the degree of fracture volume is not high, but if the included angle of the fracture surface is larger, deciding that the fracture connectivity is general, namely connectivity II; if the normal included angle between the seismic source points i and j is αᵢⱼ≤α, or the normal included angle between the seismic points i and j is βᵢⱼ≤β, considering that a fracture volume degree is not high, the included angle of the fracture surface is smaller, and the fracture connectivity is poor, and deciding the fracture connectivity as connectivity III.

8. The carbon dioxide storage target reservoirmodified fracture characterization and permeability-increasing effect evaluation method according to claim 1, characterized in that,
in step S40, determining the fracture density by utilizing the three-dimensional volume number density of the locating points comprises the following steps:
taking a certain seismic source point i′, and with the seismic source point i′ as a center of a sphere, forming a density assessment subunit within radius X′ in space, its subunit volume being V′=4/3 πX′³; if a location number in the subunit volume V′ is Nᵢ, volume number density is nᵢ′=Nᵢ′/V′; when the volume number density nᵢ′ of the locating points is greater, affirming that a fracture density is higher; if the volume number density nᵢ′ of the locating points is smaller, basically affirming that a fracture density is lower.

9. The carbon dioxide storage target reservoirmodified fracture characterization and permeability-increasing effect evaluation method according to claim 1, characterized in that,
in step S40, characterizing the rock mass permeation capability by solving the maximum eigenvalue and the corresponding eigenvector based on the fracture damage tensor specifically comprises the following steps:
S401: determining a crack damage tensor, the crack damage tensor representing an overall damage degree of a certain volume of rock mass, and being defined by a crack size and direction as:
$${ω}_{kl} - \frac{1}{V} {\sum }_{i = 1}^{N} {( {A}^{′} )}^{\frac{3}{2}} {n}_{k}^{i} {n}_{l}^{i} ;$$
wherein ωₖₗ is a damage tensor in a unit volume V of a seismic source point i, N is a number of active cracks in the unit volume, that is, the location number in the unit volume, Aⁱ is the area of an i-th crack surface, and nⁱ is a normal vector of an i-th crack;
S402: solving an eigenvalue and an eigenvector, the eigenvalue and the eigenvector of the damage tensor ωₖₗ in the unit volume V of the seismic source point i being defined as:
(ω₀δₖₗ−ωₖₗ)Uᵢ=0; wherein ω₀ is an eigenvalue of the damage tensor, δₖₗ is a unit matrix, and Uᵢ is an eigenvector of ωₖₗ corresponding to the eigenvalue ₀; letting a characteristic polynomial |ω₀δₖₗ−ωₖₗ|=0, a maximum eigenvalue ωₘ and a corresponding eigenvector Uₘ are solved;
S403: quantitatively characterizing the permeability, a rock mass damage degree being a crack development degree, a fracture development situation greatly affecting a change in a permeation rate, and in case of not considering chemical reactions and changes in external physical conditions, fracture damage being a decisive factor affecting the permeability of the storage target reservoir rock mass; wherein the maximum eigenvalue ωₘ of the damage tensor ωₖₗ represents a maximum damage degree, a maximum eigenvalue of a damage tensor in a certain area is used instead to characterize the permeability, and a corresponding eigenvector of the maximum eigenvalue is a dominant permeation direction; ωₘ is defined as a function of the permeation rate k:
ωₘ=ηk; therein, η is a correlation coefficient between the maximum eigenvalue ωₘ of the damage tensor and the permeation rate k.

10. The carbon dioxide storage target reservoirmodified fracture characterization and permeability-increasing effect evaluation method according to claim 1, characterized in that,
in step S50, assessing the permeability-increasing effect of the fracture network structure, and formulating the fracture network permeability-increasing modification plan comprises the following steps:
within a time period requiring assessment, using an assessment subunit as a unit, and according to an actual corresponding situation, from strong to weak degree, dividing the connectivity into three levels, dividing the density into two levels, dividing the permeability into three levels, and respectively assigning them with 3, 2 and 1 points from strong to weak, wherein when the density is divided into two levels, a strong level is assigned with 3, and a weak level is assigned with 2, and as monitoring and evaluation data increases and an actual geological situation is used in combination, level rating and assigned score values will be subsequently divided and adjusted more finely;
according to an evaluation of the permeability-increasing effect of the fracture network structure, a score is assigned between 9 and 4, and a fracture network permeability-increasing modification plan is formulated to increase correspondingly;
when evaluation values are 9 and 8, a target reservoir rock mass modification effect is better, and a modification is not needed; when the evaluation values are 7 and 6, the target reservoir rock mass modification effect is moderate, and injection pressure and speed in carbon dioxide storage injection parameters are adjusted; when the evaluation values are 5 and 4, the target reservoir rock mass modification effect is poor, the injection pressure and speed are increased, the density of carbon dioxide liquid is changed, a pH value of the injection liquid is adjusted, and dual physical and chemical methods are used to perform permeability-increasing modification on a target reservoir fracture network.
